(19) United States
(12) Patent Application Publication
(10) Pub. No.: US 2007/0058177 A1
(43) Pub. Date: Mar. 15, 2007

(54) Image processing apparatus and image processing method

(75) Inventor: Katsunori Teshima, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/326,189

(22) Filed: Jan. 6, 2006

(30) Foreign Application Priority Data
Sep. 14, 2005 (JP) 2005-266912

(51) Int. Cl. G06K 15/02

(52) U.S. Cl. 358/1.2; 358/448

(57) ABSTRACT

Disclosed is an image processing apparatus comprises: a resolution converter which converts resolution of an image data transferred sequentially by increasing N times a pixel number of each predetermined unit of the image data; and a parallel output section which outputs in parallel the converted image data by the unit corresponding to the predetermined unit.

### BACKGROUND

1. Field of the Invention

The present invention relates to an image processing apparatus and image processing method to convert resolution of an image by increasing each pixel of the image by N times.

2. Description of Related Art

In recent years, image formation (printing) with high resolution has been desired for an image forming apparatus such as an ink-jet printer, laser beam printer and the like, and various image processing methods has been proposed to achieve such high resolution. As a result of an image forming apparatus getting higher resolution, for example, resolution of a scanner or image data sent through a network sometimes become lower than that at image forming. In such case, it is necessary to convert resolution of the image data such as disclosed in JP Hei8-223403A.

However, when resolution conversion is performed as disclosed in JP Hei8-223403A, a processing after the resolution conversion delays unless clock frequency (processing speed) of the processing is increased. Also, when a resolution conversion and image formation are performed on a laser beam printer for example, it is necessary to increase clock frequency for driving the laser in order to achieve high-resolution printing. When clock frequency is increased as described above, it may cause electro magnetic interference (EMI) to devices around the image forming apparatus. It is necessary to take an EMI measure in order to reduce the EMI. Since the measure depends on accuracy of a semiconductor or the like, it results a higher cost.

### SUMMARY

The present invention was made in consideration of the above-described problems, and an object of the invention is to achieve resolution conversion without increasing clock frequency.

In order to achieve one of the above mentioned objects, according to one embodiment reflecting the first aspect of the invention, an image processing apparatus comprises: a resolution converter which converts resolution of an image data transferred sequentially by increasing N times a pixel number of each predetermined unit of the image data; and a parallel output section which outputs in parallel the converted image data by the unit corresponding to the predetermined unit.

Preferably, the image processing apparatus further comprises: an image processor which performs an image processing to the image data by the unit corresponding to the unit output from the parallel output section, and outputs the image data in parallel.

Preferably, the image processor performs at least one of screening and thresholding.

Preferably, the image processing apparatus further comprises: an arrangement regulator which rearranges a unit of the image data from the unit output from the parallel output section to a line unit and outputs the image data.

Preferably, the image processing apparatus further comprises: an image forming section which forms an image based on the output image data.

Preferably, the image processing apparatus further comprises: an image memory which stores the transferred image memory temporarily, wherein the resolution converter which converts resolution of the image data stored in the image memory.

In order to achieve one of the above mentioned objects, according to one embodiment reflecting the second aspect of the invention, an image processing method comprises the steps of: converting resolution of an image data transferred sequentially by increasing N times a pixel number of each predetermined unit of the image data; and outputting in parallel the converted image data by the unit corresponding to the predetermined unit.

Preferably, the image processing apparatus further comprises the steps of: performing an image processing to the image data by the unit corresponding to the unit output from the parallel output section, and outputting the image data in parallel.

Preferably, the image processing is at least one of screening and thresholding.

Preferably, the image processing apparatus further comprises the steps of: rearranging a unit of the image data from the unit output from the parallel output section to a line unit, and outputting the image data.

Preferably, the image processing apparatus further comprises the step of: forming an image based on the output image data.

Preferably, the image processing apparatus further comprises the step of: storing the transferred image memory temporarily, and converting resolution of the image data stored in the image memory.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing one example of functional constitution of an image forming apparatus to which the present invention is applied;

FIG. 2 is a block diagram showing one example of functional constitution of a second image processor;

FIG. 3 is a block diagram showing one example of functional constitution of a writing controller;

FIG. 4 is a view to explain the resolution conversion;

FIG. 5 is a view to explain parallel output of pixel data at a resolution converter;

FIG. 6 is a timing diagram to explain writing operation of an arrangement/frequency converter to a FIFO memory; and

FIG. 7 is a timing diagram to explain reading operation of the alignment/frequency converter from a FIFO memory.

### PREFERRED EMBODIMENT OF THE INVENTION

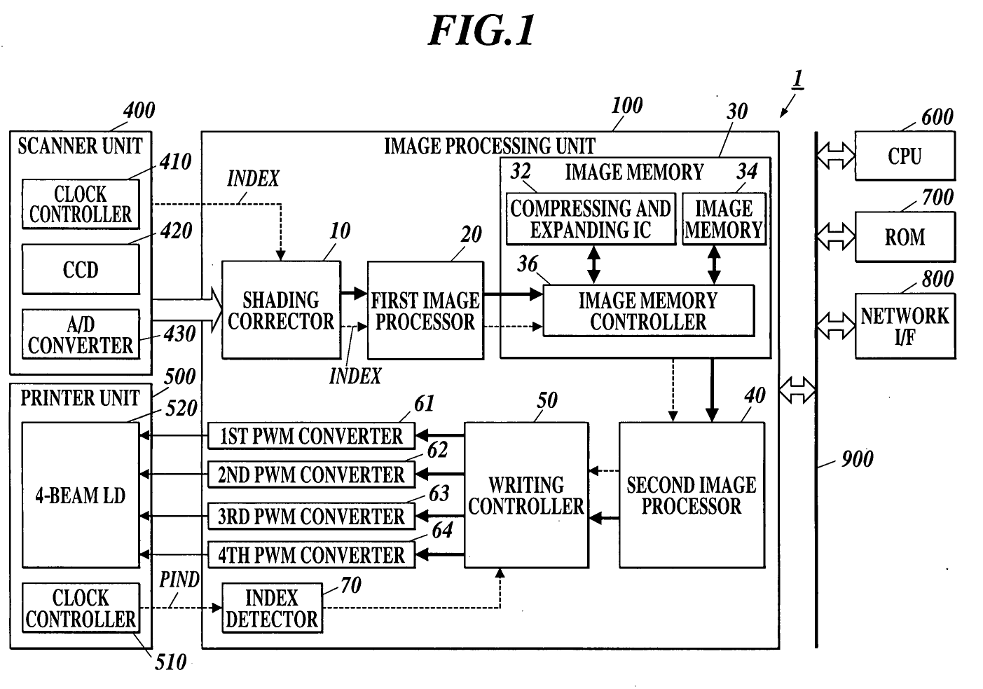

Hereinafter, an embodiment of the present invention will be described in detail with reference to FIGS. 1 to 7, where the image processing apparatus of the invention is applied to an image forming apparatus of laser electrophotography.

FIG. 1 is a block diagram showing one example of functional constitution of an image forming apparatus 1 to which the present invention is applied. As shown in FIG. 1, the image forming apparatus 1 comprises a CPU (central processing unit) 600, ROM (read only memory) 700, network I/F 800, an image processing unit 100 which performs various image processings to image data read by a scanner unit 400 and allows a printer unit 500 to form an image, and a system bus 900 to which these components are connected.

The CPU 600 is a controller to control overall sections constituting the image forming apparatus 1, and performs a processing in accordance with various processing programs such as a system program and application program stored in the ROM 700.

The ROM 700 is a memory to store various programs such as an initial program to perform various initial settings, hardware verification, loading of necessary programs and the like, system program and application program, and to store data relating operation of the programs.

The network I/F 800 is a communication interface to connect to a wired or wireless communication line, and sends and receives data to and from an external device such as a personal computer.

The scanner unit 400 is a functional device to read an original image optically and forms image data thereof, and comprises a clock controller 410, CCD (charge coupled device) 420 and A/D converter 430. The clock controller 410 forms a “synchronizing signal INDEX” composed of a vertical synchronizing signal and horizontal synchronizing signal, and sends the synchronizing signal INDEX to the image processing unit 100 while controlling operation of the CCD sensor 420.

The CCD sensor 420 scans an original with light, focuses the reflection light thereof, and performs photoelectric conversion, so as to read an image of the original and to output an analogue signal of the image to the A/D converter 430. The A/D converter 430 performs A/D conversion to the analogue image data read and formed by the CCD 420, so as to form multilevel image data, and sends the multilevel image data to the image processing unit 100 at clock frequency according to the synchronizing signal INDEX.

The printer unit 500 is a functional device to form an image on a recording medium based on a PWM (pulse width modulation) signal output from the image processing unit 100, and comprises a clock controller 510 and 4-beam LD (laser diode) 520. The clock controller 510 forms a “synchronizing signal PIND” composed of a vertical synchronizing signal and horizontal synchronizing signal, and outputs the synchronizing signal PIND to the image processing unit 100 while controlling operation of the 4-beam LD 520.

The 4-beam LD 520 emits laser beam based on the image data sent from the image processing unit 100 and exposes the image on a surface of a photosensitive drum, so as to attenuate or cancel electric charge on the exposed portion to form an electrostatic latent image.

The printer unit 500 can form an image with higher resolution than that of the scanner unit 400 by the use of the 4-beam LD 520. In the present embodiment, the scanner unit 400 reads an image at the resolution of 600 dpi (dot per inch), while the printer unit 500 prints an image at the resolution of 1200 dpi. Thus, the image processing unit 100 performs resolution conversion and converts image data of 600 dpi formed by the scanner unit 400 to image data of 1200 dpi.

The image processing unit 100 comprises a shading corrector 10, first image processor 20, image memory 30 comprising a compressing and expanding IC 32 and image memory 34, second image processor 40, writing controller 50, 1st to 4th PMW converters 61 to 64 and index detector 70. The shading corrector 10, first image processor 20 and second image processor 40 comprises a DSP (digital signal processor) and the like.

The shading corrector 10 performs correction to the image data formed by the scanner unit 400 based on white standard data and black standard data read from the scanner unit 400, so as to correct uneven sensitivity of the CCD sensor 420 and uneven brightness of the image data.

The first image processor 20 performs image processing on the image data output from the shading corrector 10, such as brightness and density conversion; region determination such as character and halftone dots; main scanning direction deformation and filtering; density Y conversion; and error diffusion.

The compressing and expanding IC 32 of the image memory 30 is an IC to compress or expand the image data according to a control of the image memory controller 36. The image memory 34 is made of DRAM and the like, and comprises a page memory to store the image data compressed or expanded by the compressing and expanding IC 32 and a buffer memory to store temporarily the image data transferred through network I/F.

The image memory controller 36 allows the compressing and expanding IC 32 to compress the image data output from the first image processor 20 and image data transferred from the network I/F 800, and allows the image memory 34 to store it temporarily. Further, the image memory controller 36 expands the compressed image data stored in the image memory 34, and outputs it to the second image processor 40.

The second image processor 40 converts resolution of the image data output from the image memory 30 from 600 dpi to 1200 dpi, performs image processing such as screening and thresholding to the image, and output the processed image to the writing controller 50.

The writing controller 50 rearranges the image data of 1200 dpi output from the second image processor 40 into each 4 pixels in a sub scanning direction, and outputs the image data to the 1st to 4th PWM converters 61 to 64 in a pixel basis. Constitutions of the second image processor 40 and writing controller 50 hereinafter will be described in detail.

Each of the 1st to 4th PWM converters 61 to 64 forms a PWM signal from the image data of pixel basis output from the writing controller 50, and outputs it to the printer unit 500. The index detector 70 detects a synchronizing signal PIND output from the clock controller 510 of the printer unit 500, and outputs the synchronizing signal PIND to the writing controller 50.

The above-described shading corrector 10, first image processor 20, image memory controller 36 and second image processor 40 sequentially transfer the synchronizing signal INDEX output from the scanner unit 400, and perform respective processings according to a clock of the synchronizing signal INDEX. On the other hand, the writing controller 50 is required to output image data according to a clock of the printer unit 500. The writing controller 50 arbitrates the processing clock to the clock of the printer unit 500 based on the synchronizing signal PIND of the printer unit 500 outputs from the index detector 70.

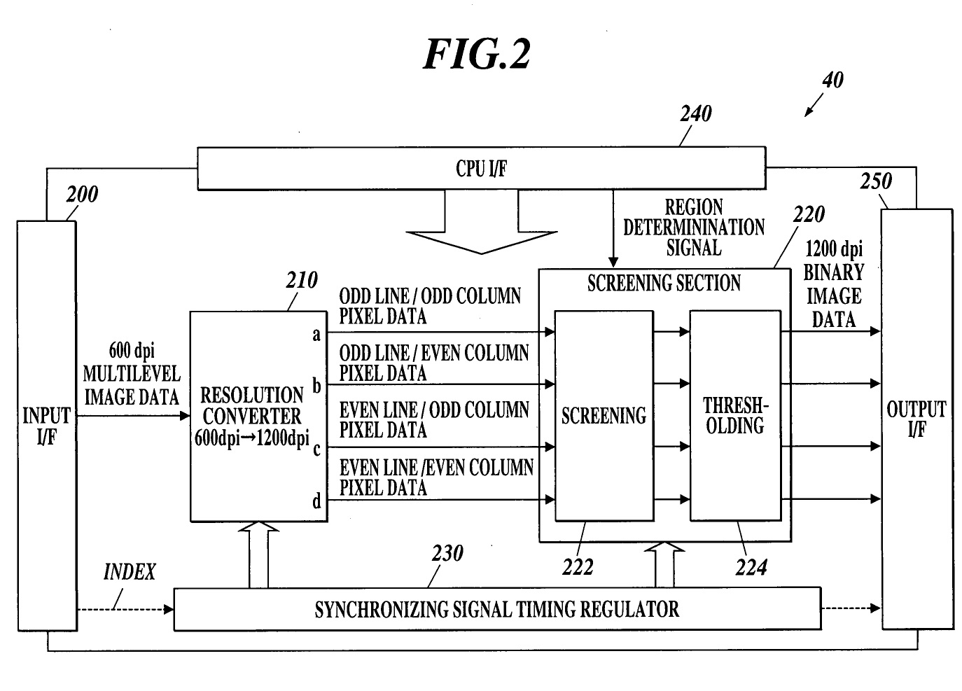

FIG. 2 is a block diagram showing one example of functional constitution of a second image processor 40. The second image processor 40 is a circuit section to perform resolution conversion, screening 222 and thresholding 224 to the input multilevel image data of 600 dpi so as to form binary image data of 1200 dpi. As shown in FIG. 2, the second image processor 40 comprises an input I/F 200, CPU I/F 240, output I/F 250, resolution converter 210, screening section 220 and synchronizing signal timing regulator 230.

The synchronizing signal timing regulator 230 controls the processing clock of the resolution converter 210 and screening section 220 based on the synchronizing signal INDEX input from the image memory through the input I/F 200.

The resolution converter 210 increases each pixel of the image data of 600 dpi input from the image memory 30 through I/F 200 by 4 times (N=4), so that the image data is converted in its resolution to the image data of 1200 dpi. Specifically, image data of each pixel of the input image data (hereinafter referred to as pixel data) is doubled in both main scanning direction and sub scanning direction so that 4 identical pixel data is formed for each pixel and are arranged.

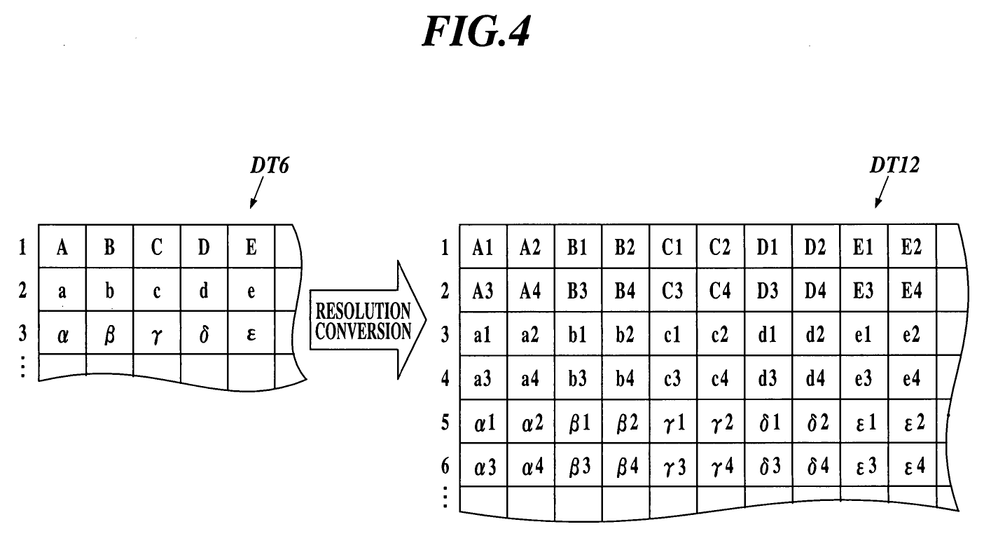

For example, a pixel data A of an image data DT6 of 600 dpi shown in FIG. 4 will be described. Four pixel data A1, A2, A3 and A4 which are identical to each other are formed, and these pixel data are arranged to be two pixels in both main scanning direction and sub scanning direction as shown in FIG. 4. Similarly, pixel data A, B, C, D, . . . on the 1st line, pixel data a, b, c, d, . . . on the 2nd line, and pixel data α, β, γ, δ, . . . on the 3rd line are increased by 4 times respectively and arranged 2×2 in main and sub scanning direction, so that an image data DT12 of 1200 dpi are formed. The resolution converter 210 performs resolution conversion of increasing N times pixel number to each predetermined unit of the transferred image data. In the present embodiment, the predetermined unit is set to one pixel, and N=4 is set where pixel number is doubled both in main scanning direction and sub scanning direction.

The quadruple image data are subject to screening 222 and thresholding 224 at the later screening section 220, where clock frequency of the processings (image processing speed) is not raised and as same as that for the image data of 600 dpi at the first image processor 20. The resolution converter 210 divides each identical 4 pixel data of the quadruple image data into four, and outputs them in parallel from terminals Pa to Pd to the screening section 220.

This parallel output is to output pixel data at odd line and odd column from the terminal Pa, pixel data at odd line and even column from the terminal Pb, pixel data at even line and odd column from the terminal Pc, and pixel data at even line and even column from the terminal Pd.

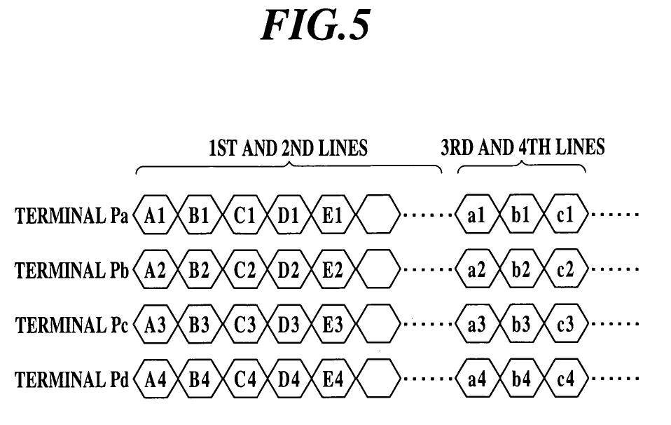

Specifically, as shown in FIG. 5, pixel data A1, A2, A3 and A4 are output in parallel firstly. Pixel data A1 at 1st line and 1st column is output from the terminal Pa, pixel data A2 at 1st line and 2nd column from the terminal Pb, pixel data A3 at 2nd line and 1st column from the terminal Pc, and pixel data A4 at 2nd line and 2nd column from the terminal Pd. Next, pixel data B1, B2, B3 and B4 are output in parallel. Pixel data B1 is at 1st line and 3rd column, pixel data B2 is at 1st line and 4th column, pixel data B3 is at 2nd line and 3rd column, and pixel data B4 is at 2nd line and 4th column. After parallel output of the pixel data at 1st and 2nd lines are finished, then parallel output of pixel data at 3rd and 4th lines are performed similarly.

The screening section 220 shifts parameters such as screen pattern and processing cycle based on a region determination signal input through the CPU I/F 240, and performs the screening 222 to the pixel data of 4-pixel unit output from the resolution converter 210 for each colors of Y (yellow), M (magenta), C (cyan) and K (black) which the image forming apparatus 1 can output, so that the image is smoothed. Then the screening section 220 performs the thresholding 224 based on a predetermined threshold value to the pixel data of 4-pixel unit where the screening 222 have been given, and output them to the writing controller 50 through terminals PA, PB, PC and PD of the output I/F 250.

As described above, since the second image processor 40 performs the processings to the pixel data of 4-pixel unit when resolution is converted by increasing each pixel of the image data by 4 times and the screening 222 and thresholding 224 is performed to the converted image data, it is not necessary to raise the clock frequency by 4 times. Further, the image memory 30 is provided prior to the second image processor 40. By doing so, it can be prevented that the image memory 34 runs out of capacity due to increase of data volume caused by the resolution conversion.

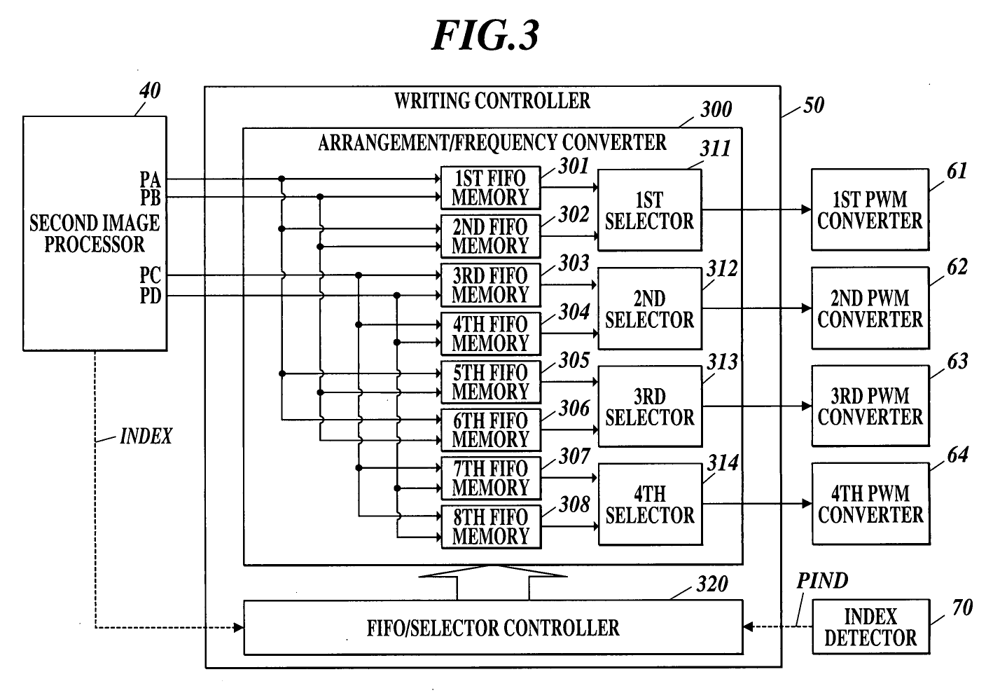

FIG. 3 is a block diagram showing one example of functional constitution of a writing controller 50. The writing controller 50 is a circuit section to arrange the image data of 4-pixel units in main scanning direction and sub scanning direction output from the second image processor 40 to image data of two-line unit constitution, and converts the clock frequency to that of printer unit 500. As shown in FIG. 4, the writing controller 50 comprises an arrangement/frequency converter 300 and FIFO (first in first out)/selector controller 320.

The arrangement/frequency converter 300 comprises 1st to 8th FIFO memories 301 to 308 and 1st to 4th selectors 311 to 314. The 1st to 8th FIFO memories 301 to 308 are memories to which the pixel data output from the terminals PA to PD of the second image processor 40 is written and from which the written data can be read out in the written order. The 1st to 4th selectors 311 to 314 each selects one of two FIFO memories alternately, and reads out the pixel data from the selected memory and outputs it to the 1st to 4th PWM converters 61 to 64.

Specifically, each of the 1st FIFO memory 301 and 2nd FIFO memory 302 stores the pixel data output from the terminals PA and PB alternately, and the 1st selector 311 selects one of the 1st and 2nd FIFO memories 301 and 302, reads out the pixel data from the selected FIFO memory, and outputs it to the 1st PWM converter 61. The 3rd and 4th FIFO memories 303 and 304 stores the pixel data output from the terminals PC and PD alternately, and the 2nd selector 312 reads out the pixel data from one of the 3rd and 4th FIFO memories 303 and 304, and outputs it to the 2nd PWM converter 62.

The 5th and 6th FIFO memories 305 and 306 stores the pixel data output from the terminals PA and PB alternately, and the 3rd selector 313 reads out the pixel data from one of the 5th and 6th FIFO memories 305 and 306, and outputs it to the 3rd PWM converter 63. The 7th and 8th FIFO memories 307 and 308 stores the pixel data output from the terminals PC and PD alternately, and the 4th selector 314 reads out the pixel data from one of the 7th and 8th FIFO memories 307 and 308, and outputs it to the 4th PWM converter 64.

The FIFO/selector controller 320 is a circuit section to control timing of writing the pixel data to the 1st to 8th FIFO memories 301 to 308 and reading by the 1st to 4th selectors 311 to 314, based on the synchronizing signal INDEX output from the synchronizing signal timing regulator 230 of the second image processor 40 and synchronizing signal PIND output from the index detector 70.

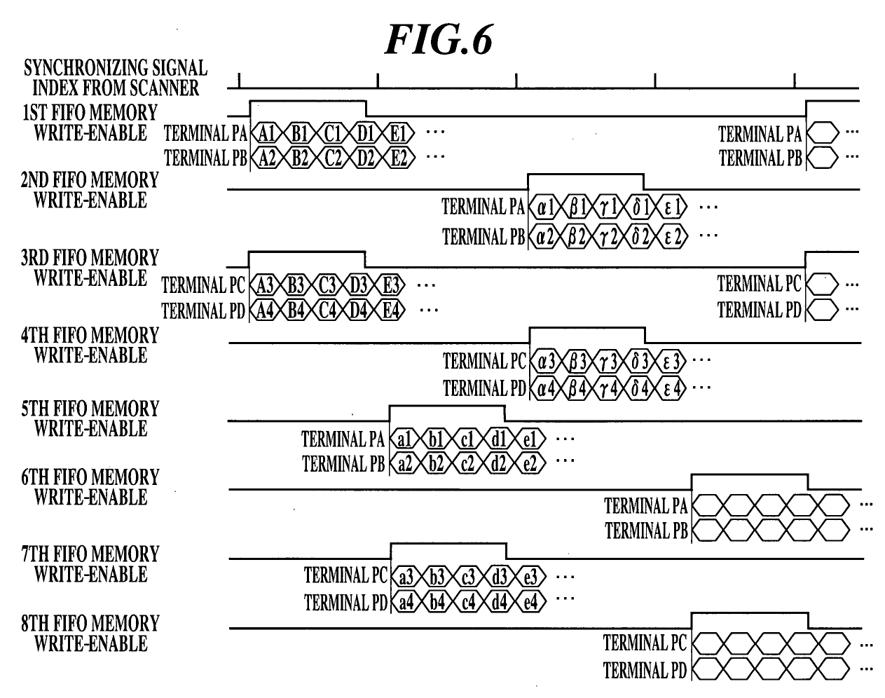

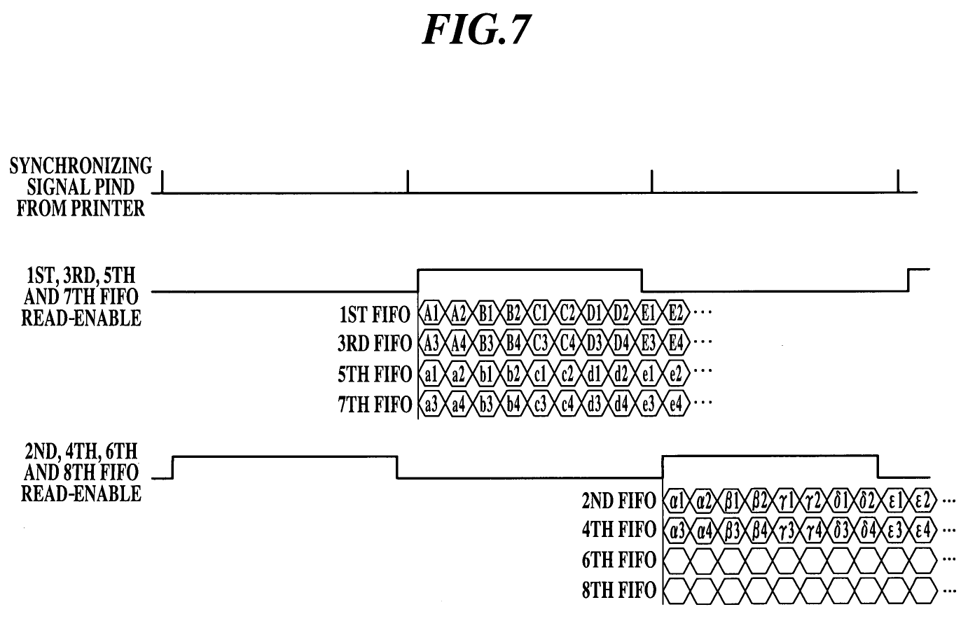

Next, practical operation of the arrangement/frequency converter 300 will be described with reference to the input and output timing diagrams of the arrangement/frequency converter 300 shown in FIGS. 6 and 7.

First, the FIFO/selector controller 320 enables writing of the 1st FIFO memory 301 and 3rd FIFO memory 303 in response to rising edge of the synchronizing signal INDEX of the scanner unit 400. The FIFO/selector controller 320 alternately writes the pixel data A1, B1, C1, . . . output from the terminal PA and the pixel data A2, B2, C2, . . . output from the terminal PB to the 1st FIFO memory 301. Further, the FIFO/selector controller 320 alternately writes the pixel data of A3, B3, C3, . . . output from the terminal PC and the pixel data A4, B4, C4, . . . output from the terminal PD to the 3rd FIFO memory 303.

As a result, the pixel data output from the terminals PA and PB are written to the 1st FIFO memory 301 in the order of A1, A2, B1, B2, C1, C2, . . . , and are rearranged as the pixel data at the 1st line of the image data DT12 shown in FIG. 4. The pixel data output from the terminals PC and PD are written to the 3rd FIFO memory 303 in the order of A3, A4, B3, B4, C3, C4, . . . , and are rearranged as the pixel data at the 2nd line of the image data DT12.

The FIFO/selector controller 320 enables writing of the 5th FIFO memory 305 and 7th FIFO memory 307 in response to the next rising edge of the synchronizing signal INDEX. Then, the FIFO/selector controller 320 alternately writes the pixel data a1, b1, c1, . . . output from the terminal PA and the pixel data a2, b2, c2, . . . output from the terminal PB to the 5th FIFO memory 305. Further, the FIFO/selector controller 320 alternately writes the pixel data of a3, b3, c3, . . . output from the terminal PC and the pixel data a4, b4, c4, . . . output from the terminal PD to the 7th FIFO memory 307.

As a result, the pixel data output from the terminals PA and PB are rearranged as the pixel data at the 3rd line of the image data DT12 shown in FIG. 4 in the order of a1, a2, b1, b2, c1, c2, . . . , and are written to the 5th FIFO memory 305. The pixel data output from the terminals PC and PD are rearranged as the pixel data at the 4th line in the order of a3, a4, b3, b4, c3, c4, . . . , and are written to the 7th FIFO memory 307.

When the FIFO/selector controller 320 finishes writing to the 1st, 3rd, 5th and 7th FIFO memories 301, 303, 305 and 307, the FIFO/selector controller 320 enables reading of the data from the 1st, 3rd, 5th, and 7th FIFO memories 301, 303, 305 and 307 in response to a rising edge of the synchronizing signal PIND of the printer unit 500. Specifically, output destinations of the 1st selector 311, 2nd selector 312, 3rd selector 313 and 4th selector 314 respectively shift to the 1st FIFO memory 301, 3rd FIFO memory 303, 5th FIFO memory 305 and 7th FIFO memory 307.

Then, the pixel data read by the 1st to 4th selectors 311 to 314 are output in parallel. The pixel data which the 1st selector 311 reads out from the 1st FIFO memory 301 is output to the 1st PWM converter 61, the pixel data which the 2nd selector 312 reads out from the 3rd FIFO memory 303 is output to the 2nd PWM converter 62, the pixel data which the 3rd selector 313 reads out from the 5th FIFO memory 305 is output to the 3rd PWM converter 63, and the pixel data which the 4th selector 314 reads out from the 7th FIFO memory 307 are output to the 4th PWM converters 64, respectively.

That is, the 1st PWM converter 61 converts the pixel data A1, A2, B1, B2, C1, C2, . . . to PWM signals, the 2nd PWM converter 62 converts the pixel data A3, A4, B3, B4, C3, C4, . . . to PWM signals, the 3rd PWM converter 63 converts the pixel data a1, a2, b1, b2, c1, c2, . . . to PWM signals, the 4th PWM converter 64 converts the pixel data a3, a4, b3, b4, c3, c4, . . . to PWM signals, and these PWM signals are sequentially output to the 4-beam LD 520. As a result, the image on the 1st and 2nd lines of the image data DT12 is formed in main scanning direction by 4-pixel unit in sub scanning direction.

While the pixel data are read out from the 1st, 3rd, 5th and 7th FIFO memories 301, 303, 305 and 307, the FIFO selector controller 320 enables writing of the pixel data to the 2nd FIFO memory 302 and 4th FIFO memory 304 in response to the synchronizing signal INDEX and writes the pixel data output from the terminals PA to PD, and then enables writing of the pixel data to the 6th FIFO memory 306 and 8th FIFO memory 308 and writes the pixel data output from the terminals PA to PD.

While the pixel data are written to the 2nd, 4th, 6th and 8th FIFO memories 302, 304, 306 and 308, the FIFO/selector controller 320 enables reading of the data from the 2nd, 4th, 6th and 8th FIFO memories 302, 304, 306 and 308 after finishes reading from the 1st, 3rd, 5th and 7th FIFO memories 301, 303, 305 and 307. That is, output destinations of the 1st selector 311, 2nd selector 312, 3rd selector 313 and 4th selector 314 respectively shift to the 2nd FIFO memory 302, 4th FIFO memory 304, 6th FIFO memory 306 and 8th FIFO memory 308. Pixel data are read out from the 2nd, 4th, 6th and 8th FIFO memories 302, 304, 306 and 308 in response to the synchronizing signal PIND, and the read pixel data are output to the 1st to 4th PWM converters 61 to 64 in parallel. As a result, the image on the 3rd and 4th lines of the image data DT12 is formed.

According to the present invention as described above, image data is output in parallel by the unit of image data corresponding to the predetermined unit at the resolution conversion, after the resolution conversion of the transferred image data. More specifically, the resolution converter 210 converts the resolution of the image data transferred through the scanner unit 400 and network I/F by increasing each pixel of the image data by 4 times, and outputs the converted 4 pixel data corresponding to the original pixel data in parallel.

By doing so, the screening section 220 at the later step can perform the screening 222 and thresholding 224 to the pixel data of the image data by 4-pixel unit. Thus, the screening section 220 can perform the processings at the clock frequency as same as that of the previous shading corrector 10 and first image processor 20, i.e. that of the scanner unit 400. Thus, it is possible to convert resolution of the image data and to perform image processing to the image data converted to higher resolution and image forming thereof, without raising the clock frequency.

Further, the image data which was subject to the screening 222 and thresholding 224 by 4-pixel unit are rearranged to the image data of line units at the writing controller 50, and are output it in parallel, and the 4-beam LD 520 forms the image by 4-pixel unit. Thus, it is possible to form the image without raising the clock frequency which drives the 4-beam LD 520. As a result, it becomes possible to prevent electric magnetic interference on various external devices of the image forming apparatus 1.

The above-described embodiment is one example of the invention, thus the scope of the invention is not limited thereto and can be modified optionally. For example, the resolution converter 210 converts resolution by increasing each pixel of the image by 4 times in the embodiment. The resolution converter 210 can converts resolution by increasing each pixel of the image by 3×3 times in both main scanning direction and sub scanning direction. In such case, the resolution converter 210 outputs the pixel data of the converted image data in parallel in the order of the pixel data at 1st line and column n (n=1, 4, 7, 10, . . . ), 1st line and column n+1, 1st line and column n+2, 2nd line and column n, 2nd line column n+1, 2nd line and column n+2, 3rd line and column n, 3rd line and column n+1, and 3rd line and column n+2. By doing so, 9 pixel data corresponding to an original pixel data before resolution conversion are output to the screening section 220, and the pixel data are subject to the screening 222 and thresholding 224.

The arrangement/frequency converter 300 stores the pixel data output in parallel from the second image processor 40 to the FIFO memories by 3-pixel unit, so that the pixel data can be rearranged to the pixel data of line unit. The multiple number N of the resolution conversion is not limited to 4 and 9, and can be 16, 25, . . . , the screening section 220 and writing section 50 respectively comprises N terminals to input and output the data.

Further, the present invention is described with an example where the image data are read on and transferred from the scanner unit 400 and are subject to the resolution conversion. It is apparent that the similar effect of the invention also can be obtained in the case that the image data are transferred from an external personal computer through the network I/F 800, and is subject to the resolution conversion. The image processing apparatus of the invention can be applied to image forming apparatuses such as a printer, FAX, copier and multi function peripheral and the like.

The present U.S. patent application claims a priority under the Paris Convention of Japanese patent application No. 2005-238561 filed on Aug. 19, 2005, and is entitled to the benefit thereof for a basis of correction of an incorrect translation.

What is claimed is:

1. An image processing apparatus comprising:
a resolution converter which converts resolution of an image data transferred sequentially by increasing N times a pixel number of each predetermined unit of the image data; and
a parallel output section which outputs in parallel the converted image data by the unit corresponding to the predetermined unit.

2. The image processing apparatus of claim 1, further comprising:
an image processor which performs an image processing to the image data by the unit corresponding to the unit output from the parallel output section, and outputs the image data in parallel.

3. The image processing apparatus of claim 2, wherein the image processor performs at least one of screening and thresholding.

4. The image processing apparatus of claim 2, further comprising:
an arrangement regulator which rearranges a unit of the image data from the unit output from the parallel output section to a line unit and outputs the image data.

5. The image processing apparatus of claim 1, further comprising:
an image forming section which forms an image based on the output image data.

6. The image processing apparatus of claim 1, further comprising:
an image memory which stores the transferred image memory temporarily, wherein the resolution converter which converts resolution of the image data stored in the image memory.

7. An image processing method comprising the steps of:
converting resolution of an image data transferred sequentially by increasing N times a pixel number of each predetermined unit of the image data; and
outputting in parallel the converted image data by the unit corresponding to the predetermined unit.

8. The image processing method of claim 7, further comprising the steps of:
performing an image processing to the image data by the unit corresponding to the unit output from the parallel output section, and outputting the image data in parallel.

9. The image processing method of claim 8, wherein the image processing is at least one of screening and thresholding.

10. The image processing method of claim 8, further comprising the steps of:
rearranging a unit of the image data from the unit output from the parallel output section to a line unit, and outputting the image data.

11. The image processing method of claim 7, further comprising the step of:
forming an image based on the output image data.

12. The image processing method of claim 7, further comprising the step of:
storing the transferred image memory temporarily; and
converting resolution of the image data stored in the image memory.
